(19) United States
(12) Patent Application Publication
(10) Pub. No.: US 2013/0045624 A1
(43) Pub. Date: Feb. 21, 2013

(54) PRE-WIRED ELECTRICAL DEVICE

(71) Applicant: Robert V. Snyder, Mechanicsburg, OH (US)

(72) Inventor: Robert V. Snyder, Mechanicsburg, OH (US)

(21) Appl. No.: 13/401,458

(22) Filed: Feb. 21, 2012

Related U.S. Application Data
(60) Provisional application No. 61/444,884, filed on Feb. 21, 2011.

(51) Int. Cl. H01R 13/60

(52) U.S. Cl. 439/535

(57) ABSTRACT

Disclosed embodiments describe pre-wired electrical devices for simplifying and expediting the wiring of structures. Much time and expense is devoted to wiring of structures during construction. Devices which can facilitate and speed-up this process are needed in the construction industry. Disclosed embodiments describe an apparatus designed to allow an electrician to install a pre-wired outlet and quickly connect it to an electrical power source during the early stages of construction. The apparatus then allows for a quick modification to complete the outlet for use, after the walls of the structure are complete. It accomplishes this by providing outlets with a pre-wired outlet within the housing, connected via relay wires to a connector housing that is adapted to quickly receive and secure transmission wires. Moreover, the apparatus comprises simplified connection port for accepting transmission wiring coupled to a pre-wired outlet.

### CROSS-REFERENCE TO RELATED APPLICATIONS

This Nonprovisional patent application claims the benefit of U.S. Provisional Application No. 61/444,884 filed on 21 Feb. 2011, the content of which is hereby incorporated by reference as if fully recited herein.

### TECHNICAL FIELD

The present invention relates to an improved device for simplifying the wiring of a structure.

### BACKGROUND

Electricians are generally paid by the hour and are often paid one of the highest wages of the craftsmen constructing a building; therefore, anything that can improve an electrician's efficiency or otherwise reduce the amount of time that electricians are needed on a construction site can have a substantial effect on the bottom line for a construction project.

Conventionally, devices exist which require a skilled craftsmen to make multiple visits to a project location over an extended period of time. For example, an electrician installs an electrical box that will house a three prong electrical outlet. On a first visit, the electrician would fasten the box to a structural support. Then the electrician would run wires from an electrical source to the box. The wires would be bound up and left inside the box, because the electrician cannot finish installation until, e.g., sheet rock, wood, tiling, fiber board or other paneling is installed. Then on a second trip, which may be days, weeks or months later, the electrician would connect each individual wire to each terminal inside each box. The installation would be different for each different type of electrical box, in that the installation procedure for an electrical outlet is not that same as for a telephone outlet. The multiple visits coupled with the different installation procedures—with associated and required intricate knowledge—increase the project's costs due to the electrician's services. Furthermore, varied wiring procedures increase the risk of error. However, a device as described in the following detailed description provides advantages over conventional devices.

### SUMMARY

In an example pre-wired electrical device embodying the principles of this invention, an electrical socket and housing is fully installed in a structure during a single visit by an electrician at which time the electrician attaches wires to the electrical socket's terminal box which leads to the socket. Wiring within the housing, is already prepared by the housing's manufacturer. When the structure is nearly completed, the socket is adapted for movement, from a recessed first position to a second forward position to install a face plate. The pre-wired electrical device eliminates the need not only for multiple visits but also for different installation procedures for each different type of electrical box, and it cuts down on errors by reducing complexity. This and other unmet advantages are provided by the device and method described and shown in more detail below.

Example embodiments of the present invention including housings for electrical devices commonly found in residential or commercial edifices such as electrical outlets, pre-wired junction boxes, electrical switches or controls, telephone outlets, cable television outlets, internet connection outlets, security system interfaces, or lighting, heating, cooling and/or intercom interfaces.

### BRIEF DESCRIPTION OF THE DRAWINGS

A better understanding of the disclosed embodiments will be obtained from a reading of the following detailed description and the accompanying drawings wherein identical reference characters refer to identical parts:

FIG. 1 is a front elevation view of a partially assembled pre-wired electrical device;

FIG. 2 is a cut away side elevation view of a partially assembled pre-wired electrical device;

FIG. 3 is an example embodiment front perspective view of a housing means of a pre-wired electrical device with positioner and securing means;

FIG. 4 is a rear perspective view of a pre-wired electrical device with connection means and securing means;

FIG. 5 is a rear perspective view of a pre-wired electrical device;

FIG. 6 is an isolation view of toothed arm contact means;

FIG. 7 is a side cut away view of a connection means with relay means, contact means and securing means;

FIG. 8 is a rear elevation zoomed in view of connection means with contact means;

FIG. 9 is an isolation view of a physical connection between the output means and a relay means;

FIG. 10 is a front perspective view of a junction box system of the pre-wired electrical device; and,

FIG. 11 is a front perspective cut away view of a relay means showing physical connection between the output means and the connection means.

FIG. 12 is a perspective view of a schematic drawing of an embodiment of a pre-wired electrical device.

FIG. 13 shows two views of an embodiment of a pre-wired electrical box.

FIG. 14 shows two views of an embodiment of a pre-wired electrical box.

FIG. 15 shows an embodiment of a connector housing and a transmission wire.

FIG. 16 shows several views of an embodiment of a prewired electrical box.

FIG. 17 shows a partially exploded view of a prewired electrical box with transmission wires being inserted.

FIG. 18 shows several views of an embodiment of a pre-wired electrical box in use within a structure.

### DETAILED DESCRIPTION

The terms “a” and “an” and “the” and similar references used in the context of describing the disclosed embodiments (especially in the context of the following claims) are to be construed to cover both the singular and the plural, unless otherwise indicated herein or clearly contradicted by context.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the disclosed embodiments and does not pose a limitation on the scope of the disclosed embodiments unless otherwise claimed. No language in the specification should be construed as indicating any non-claimed element essential to the practice of the disclosed embodiments or any variants thereof.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Preferred embodiments of this invention are described herein, including the best mode known to the inventors for carrying out the invention(s). Of course, variations on the disclosed embodiments will become apparent to those of ordinary skill in the art upon reading the foregoing description. The inventors expect skilled artisans to employ such variations as appropriate, and the inventors intend for the invention(s) to be practiced otherwise than specifically described herein. Accordingly, this disclosure includes all modifications and equivalents of the subject matter recited in the claims appended hereto as permitted by applicable law. Moreover, any combination of the above described elements in all possible variations thereof is encompassed by the disclosed embodiments unless otherwise indicated herein or otherwise clearly contradicted by context.

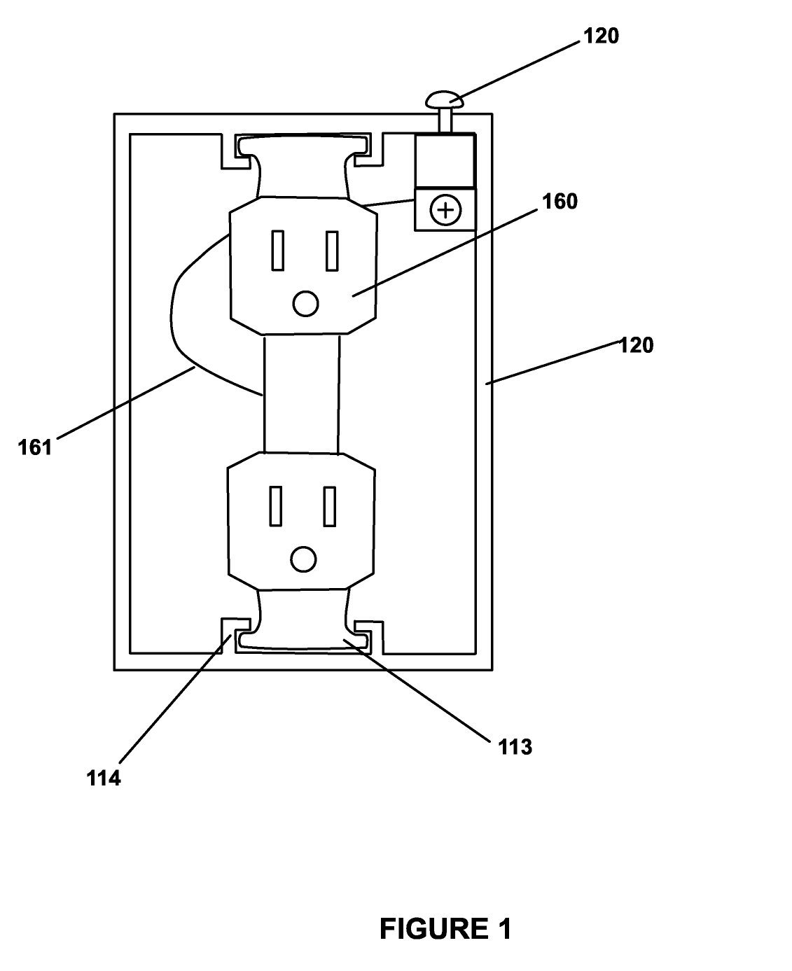

FIG. 1 depicts an example embodiment of a pre-wired electrical box; the box comprises a substantially rectangular housing 100. In another embodiment the housing can be enclosed on a fifth and/or a sixth side. The housing means can take on any cross sectional shape which as appropriate for containing wires carrying electrical current. Alternative example embodiments of the housing means have a cross section of any shape, such as a circle, triangle, rectangle, pentagon, hexagon, octagon or cross. The alternative example embodiments of the housing means can be enclosed on all sides, so as to substantially encapsulate an outlet 170, shown in FIG. 1 as electrical outlet. The alternative example embodiment of the housing can be enclosed on less than all sides so as to partially encapsulate the outlet while permitting a skilled craftsmen access to it. Regardless of shape, the housing can be made from any material or combinations of material which are suitable for holding wires which carry electrical current. Example materials include wood, plastic, glass and/or metal. The pre-wired electrical box further comprises a positioner 113 constrained by a journal 114 such that the positioner may substantially only move in a back to front and/or front to back plane in reference to housing. The box shows a relay plug 160 which accepts electrical current from a transmission wire (not shown) and transfers the electrical current through relay wire 161 to outlet, and shows a fastener 120 that affixes a transmission wire (not shown) within a connection port (not shown).

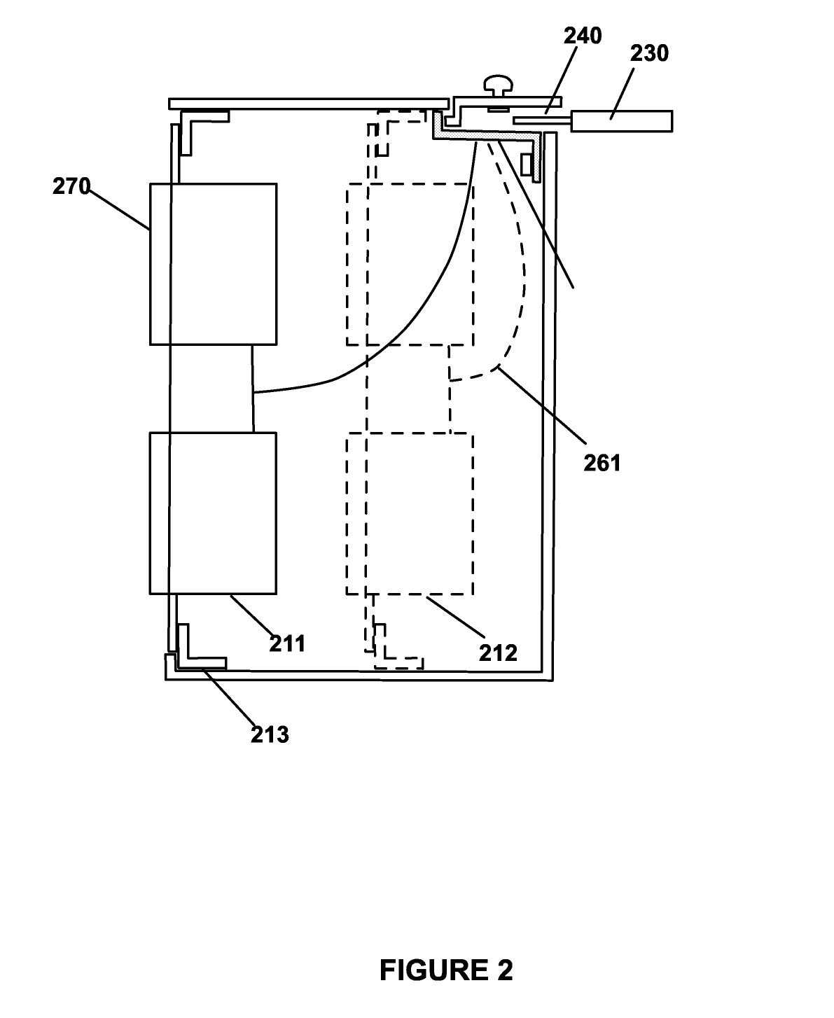

FIG. 2 shows an embodiment of a pre-wired electrical box comprising a housing 200 and an outlet 270 wherein the outlet is shown as sliding from a first position, represented by dashed lines, to a second position, represented by solid lines; and a transmission wire 230 in a condition to be accepted by a connection port 240. The figure shows an example embodiment of a positioner 213 constrained by a journal (not pictured) such that the positioner may substantially only move in a back to front and/or front to back plane in reference to the housing 200. The positioner is detachably connected to the outlet and permits an installer to move the outlet from a first position 211 to a second position 212. An alternate example embodiment of a positioner is a screw which is substantially fixed in a front to back plane to the housing on at least one end but permitted to rotate freely. The screw passes through a threaded aperture of the outlet 270 which permits the outlet to travel from a first position 211 to a second position 212 by turning the screw. In this example embodiment of the positioner, securing means are optional. In an alternate example embodiment, the positioner use magnetic forces to move the outlet from a first and second position. In any embodiment of this invention, the positioner can be (1) singular, i.e. only one positioner is necessary such as the screw type, or (2) plural, i.e. multiple positioner such as the slide type. FIG. 2 shows transmission wire 230 stripped of at least one layer of wire insulation to permit transmission of electrical current from transmission wire 230 to relay plug 260. Whether or not transmission wire 230 needs to be stripped of at least one layer of insulation depends on the nature of contact means inside the connection port. In an embodiment, the transmission wire may be any wire type that meets state and federal regulations for the transmission of electrical current within a structure, specifically; the wire may be Romex wire. In an embodiment, the electrical current is transferred from the transmission wire to the relay plug, to relay wire 261 to outlet 270. In this embodiment, housing 200 has a connection port 240 which may be located on any surface of housing 200. Connection port 240 is defined by a void in the housing which is of a size and shape to permit insertion of a transmission wire 230. Optionally, the pre-wired electrical box employs a fastener such as screw 220 to affix transmission wire 230 within a connection port 240.

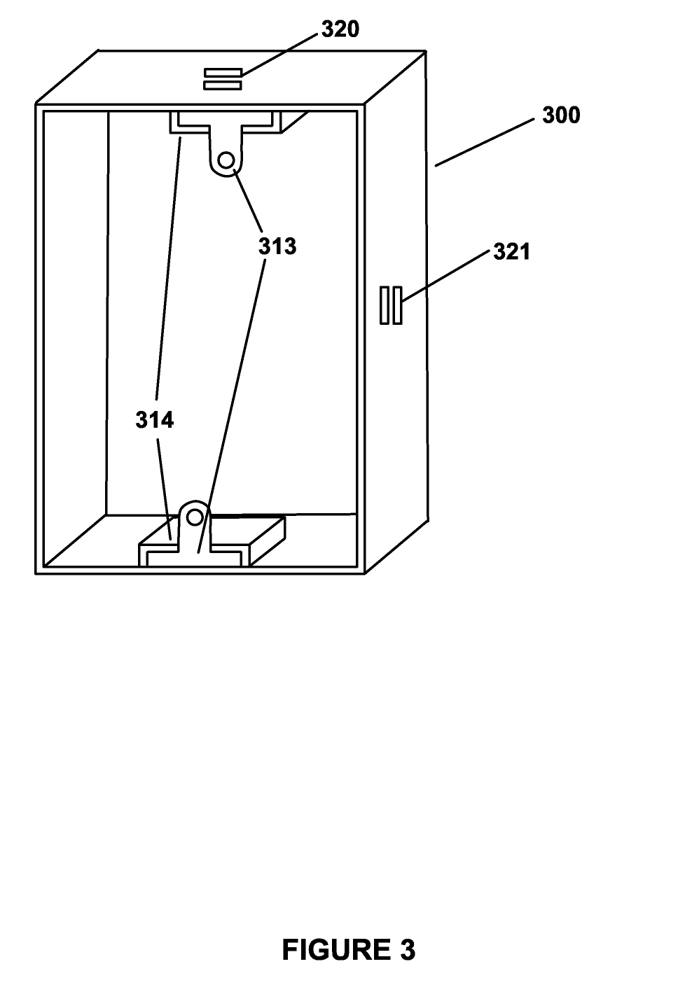

FIG. 3 shows an example embodiment of a pre-wired electrical box 300. In this embodiment, the box comprises securing means defined by two sets of substantially parallel voids 320 and 321 in housing 300 which can either fully or partially pass through the housing, the voids are sized and shaped to compliment the positioner (not shown) to secure the outlet. In another example embodiment, the securing means can be a void which passes entirely through the housing which permits the insertion of a rigid object, e.g. a set screw or a rod. In another example embodiment, the securing means use magnetic forces to hold the outlet in a first and second position. The voids 320 and 321 can be used together or separately, in that either voids 320 or 321 are sufficient to secure the outlet in a first and/or second position, respectively. In another example embodiment, the securing means comprises a lip which engages against output means and/or positioner when the outlet is moved from a first position to a second position. The purpose of the securing means is to hold the outlet in a first position during a first installation process where a skilled craftsman secures the housing means in an edifice. A person can then move the output means into a second position when, e.g., construction is completed. The securing means then holds the outlet in the second position.

FIG. 3 shows an example embodiment of positioner where the positioner is represented by a slider 313 constrained by a journal 314 such that the slider 313 may substantially only move in a back to front and/or front to back plane relative to housing 300.

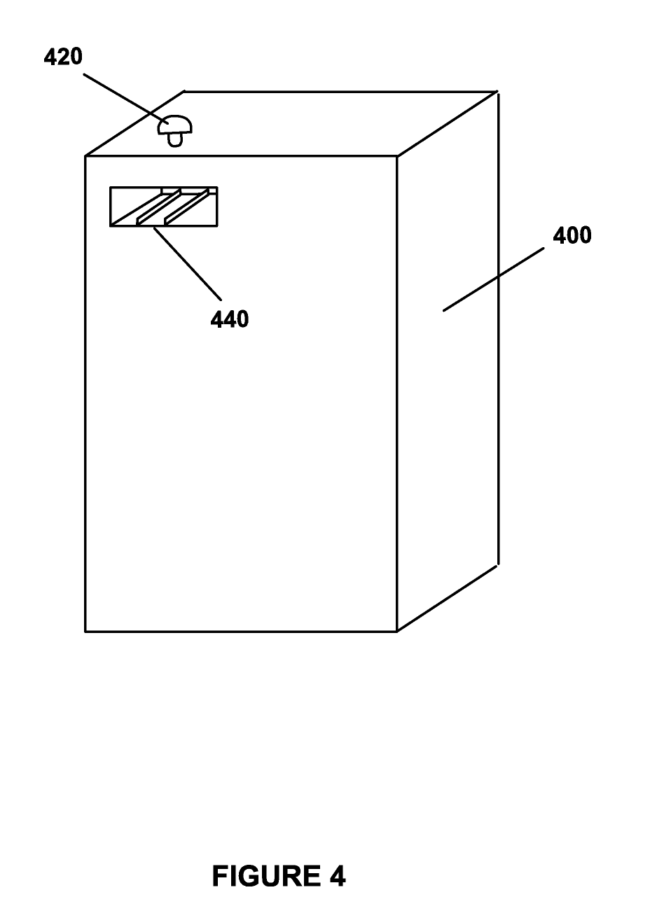

FIG. 4 is an example embodiment of a pre-wired electrical box. Housing 400 has a connection port 440 which may be located on any surface of housing 400, in this embodiment; it is positioned in what is functionally, the rear of the housing, the side opposite that of the outlets after installation. Connection port 440 is defined as a void in the housing which is of a size and shape to permit the insertion of a transmission wire (not shown). Alternatively, the connection port is adapted to retain the transmission wire with a fastener 420 such as, for example the screw shown, optionally, the fastener may press downward onto a set plate, rather than press directly into the inserted transmission wire. In this example embodiment, a transmission wire (not pictured) is inserted into the connection port, and screw 420 passes through the housing to hold the wire in place during operation of the pre-wired electrical device. In another example embodiment, the wire is retained by an arm or plate which holds the transmission wire in place. The arm or plate can be pushed into contact with the transmission wire and held in that position by a fastener. In another example embodiment, the plate can use the elastic properties of plastic or metal to exert force on the transmission wire to hold it within the connection port. In another example embodiment, the pre-wired electrical device comprises a complimentarily shaped plug and void to retain transmission wire within the connection port.

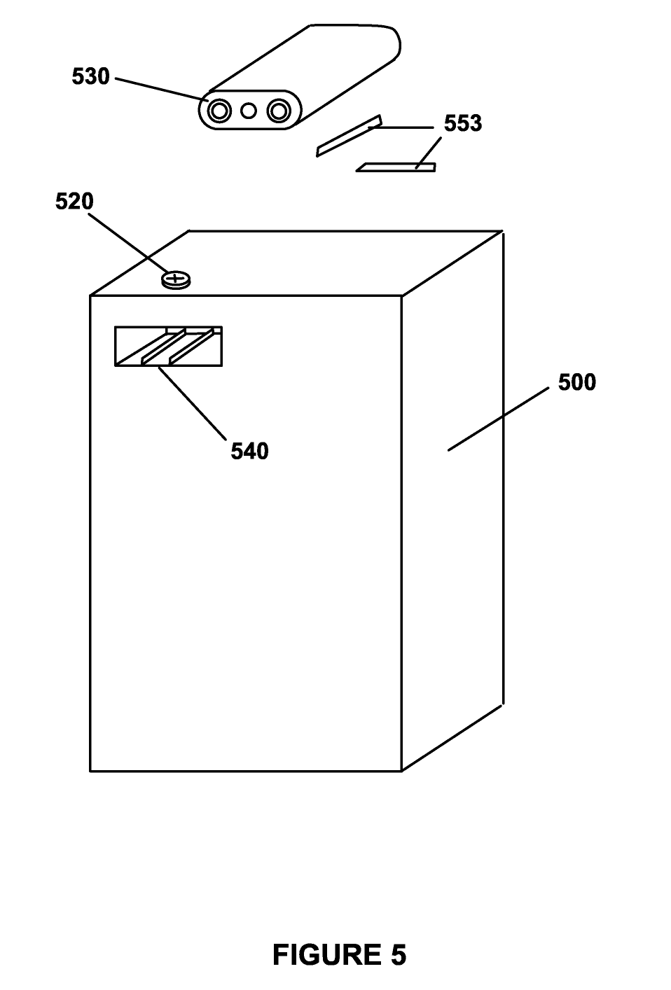

FIG. 5 is an example embodiment of a pre-wired electrical device 500. Here, an embodiment of a connection port is shown adapted to complement a knife 553. The knife 553 pierces the insulation of the transmission wire 530 to the extent that each individual metal strand is in contact with just one knife 553. In an example embodiment, the transmission wire 530 has three copper strands which require the relay plug to contain a conductive surface of a respective knife 553. The purpose of the knife is to permit transmission of electrical current from the transmission wire 530 to relay plug; therefore, the shape, size and number of knives is dependent on the shape, size and material of strands inside the transmission wire 530.

FIG. 5 shows a screw 520 which is used to retain the transmission wire and/or any adapter between the transmission wire and the pre-wired electrical device, within the connection port.

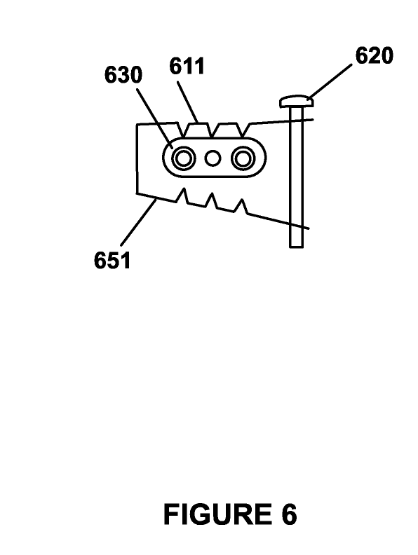

FIG. 6 shows an example embodiment of contacts with the connection port. In operation of the device, these are moved perpendicularly to a longitudinal axis of the transmission wire 630 from a first position 611 to a second position. In an example embodiment of the movable contacts, a toothed arm 651 is lowered onto the transmission wire 630 which pierces the insulation of transmission wire 630. The toothed arm 651 is lowered by a force applied in a direction substantially perpendicular to the longitudinal axis of the transmission wire 630. In an example embodiment, the force is applied by the rotation of a screw, such as screw 620. Screw 620 passes through the housing (not pictured). In an example embodiment, screw 520 and screw 620 are the same part. In another example embodiment, force is applied directly on the toothed arm 651 rather than using screw 620 to displace toothed arm 651. In another example embodiment, the toothed arm is opposed by a second toothed arm 652, of the same or different geometry. The second toothed arm can be stationary or movable by the same or different forces which move toothed arm. In an example embodiment, toothed arm hinges about a point such that the motion of toothed arm is substantially radial to transmission wire. In another example embodiment, toothed arm translates downward such that toothed arm at the first position 611 would be substantially parallel to toothed arm at the second position.

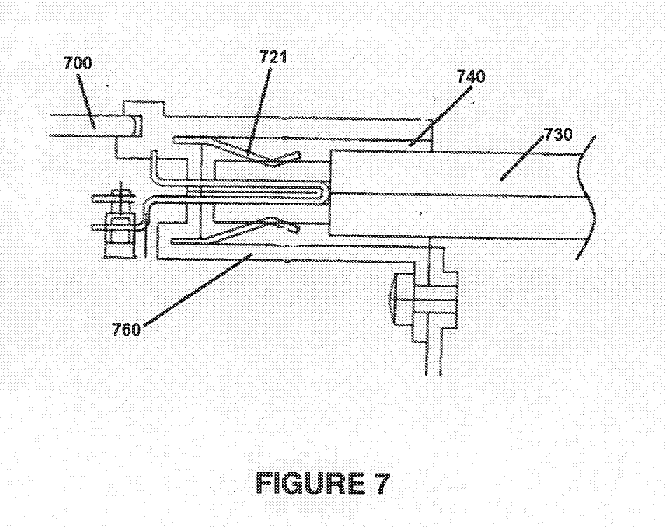

FIG. 7 shows an example embodiment of a pre-wired electrical device using relay plug 760 which is detachably connected to housing 700 at connection port 740. In an example embodiment, connection port receives transmission wire 730 which becomes fixed within relay plug 760. Transmission wire is stripped of at least one layer of insulation. In another example embodiment, transmission wire is not stripped of any insulation such that contacts access individual strands to transfer electrical current. In another example embodiment, fasteners or tabs are used to hold transmission wire within the connection port. In example an embodiment, fasteners 721 are displaced by transmission wire, the fasteners pinch together to hold transmission wire within the connection port. In an embodiment, the fasteners include tabs. In another example embodiment, the fasteners also act as means to relay electrical current to output means (not pictured).

An advantage to having a relay plug which is detachably connected to the housing is that the relay plug can be specialized for each individual outlet and/or connection port, i.e. the housing can be standardized for many different outlets with only the plug—and its contacts and connection port counterparts—to adapt to the housing. In this example embodiment, a skilled craftsman could create an optimal pre-wired electrical device based on a specific transmission wire and outlet necessary to complete a wiring project. An advantage to having relay plug fixed to the housing is that the relay plug—and its contacts and connection counterpart—are optimized and standardized for each type of outlet so that a skilled craftsmen can install the prewired electrical device in two steps: (1) secure housing means to a structural support; and, (2) insert a transmission wire into a connection port.

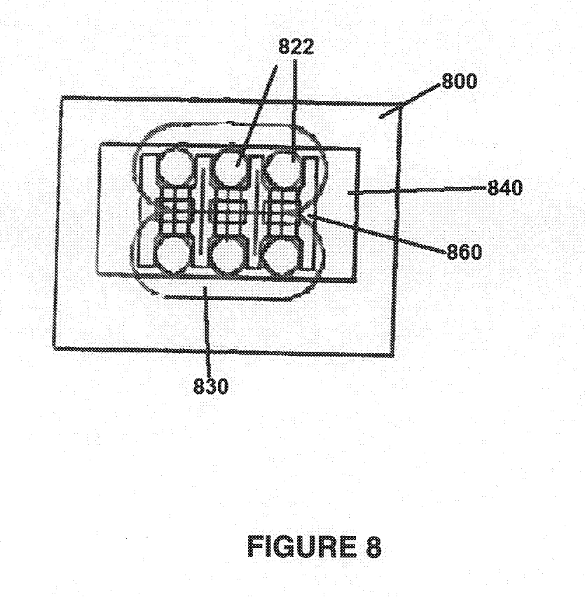

FIG. 8 shows another example embodiment where contact means are individual sockets 822 which accept each individual strand of transmission wire 830. In the example embodiment shown, there are six sockets; however, the number of sockets depends on the number of individual strands of transmission wire. Sockets are fixed within connection port 840. The size of the sockets are such that the individual strands of transmission wire are adapted to sockets using friction, compression, tension or adhesion. In an example embodiment, sockets are connected to relay plug 860 which transfers electrical current from transmission wire to outlet (not pictured) using relay means (not pictured).

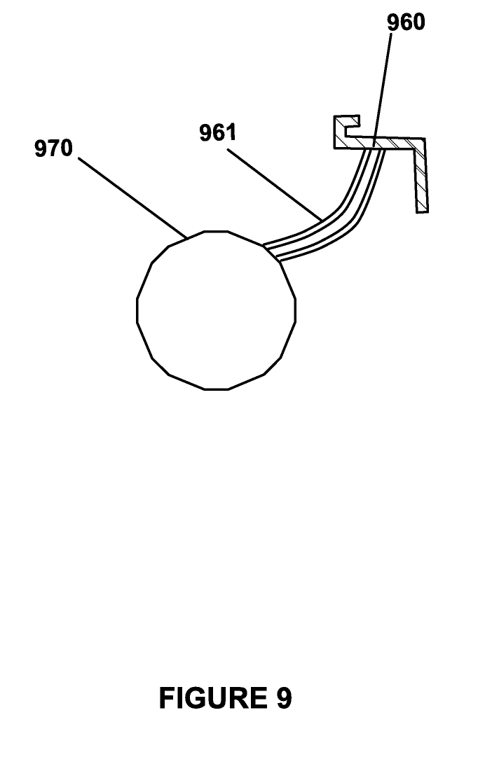

FIG. 9 shows an example embodiment of transmission of electrical current from a transmission wire (not shown) through a contact (not shown) to the outlet. Electrical current passes from the contact means (not shown) to relay plug 960 to relay wires 961 to outlet 970. Outlet plug 970 has no shape or features, because it can be any type of outlet plug discussed above. Three relay wires 961 are shown in FIG. 9; however, the number of relay wires 961 depends on the number of strands in the transmission wire (not shown) carrying electrical current.

In an example embodiment, the contact within the relay plug is removable. One advantage to having the contacts in separable connection is that the skilled craftsman can choose the type of contact means which the craftsman prefers. A second advantage to having the contacts and the relay plug separable is that the size of the contacts can be adjusted for different size transmission wires 930. In an another example embodiment, the relay plug and the contacts are one unified piece; however, the unified piece must be constructed in a manner which prevents a short circuit of electrical current from the transmission wire 930.

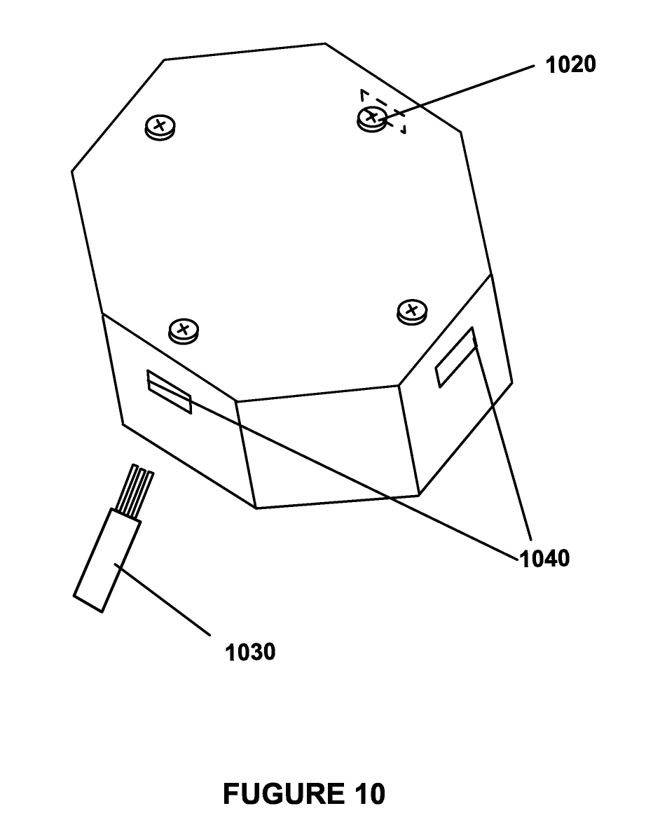

FIG. 10 shows an example embodiment of the present invention as a junction box. The present invention junction box permits the input of a transmission wire into one or more connection ports which is in electrical communication with one or more outlets. The junction box comprises a housing. Housing 1000 has one or more connections ports 1040 which accepts transmission wire 1030. Electrical current is transferred from transmission wire 1030 via relay means (not pictured) to one or more outlet plugs.

The junction box can contain any number of connection ports 1040 and outlets which can be sustained using sound electrical wiring practices. In an example embodiment, the connection port 1040 can be used as an outlet 1070, if necessary, as long as there is at least one connection port which accepts a transmission wire 1030. Transmission wire 1030 is held within connection port 1040 by a fastener, such as screw 1020 or tabs as shown above.

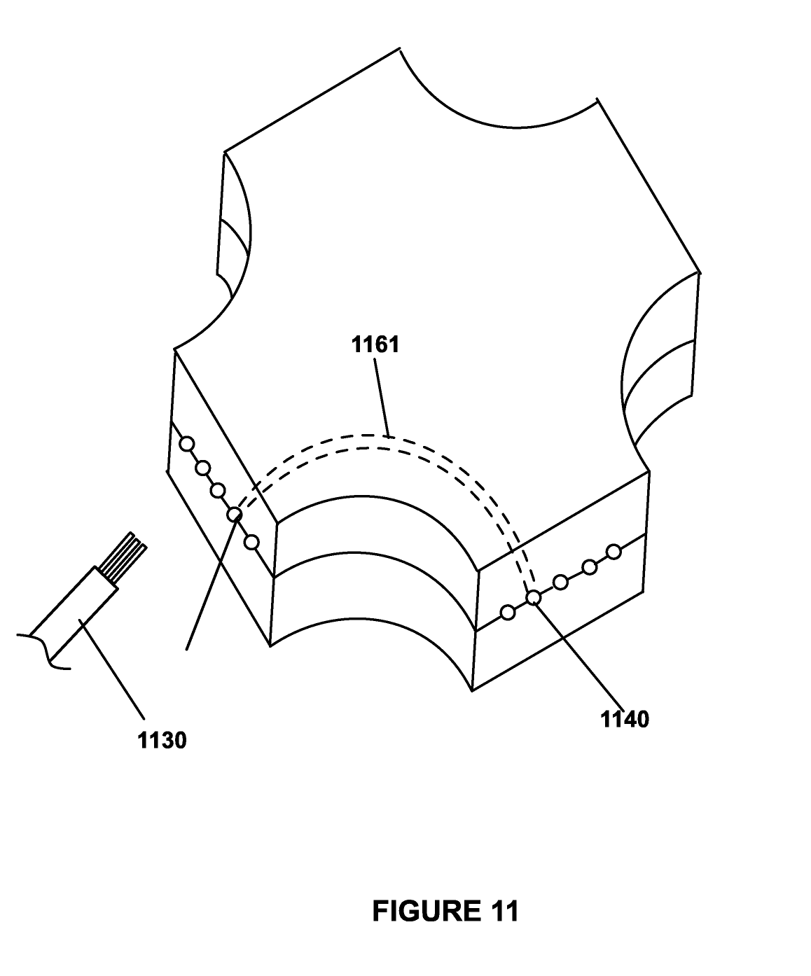

FIG. 11 shows an example embodiment of a junction box where junction housing (not pictured) contains within it a junction system. The relay wire 1161, represented as a dashed line, is only an example embodiment of how the relay plug and the outlet may be electrically connected, in that connecting port 1140 need not necessarily be connected to outlet 1170. Which connection means are connected to which outlet depends on consumer demands or manufacturers' choice. In an example embodiment, connection port can accept one or more strands within a transmission wire 1130. In such an example, relay wire would contain a number of relay wires which effectively transmits the electrical currents.

In another example embodiment, junction system 1160 can be opened before, during or after installation. In such an example embodiment, relay wire 1161 can be moved such that the connection port and/or outlet which the wire connects can be changed. In this example embodiment, relay wire can be repaired.

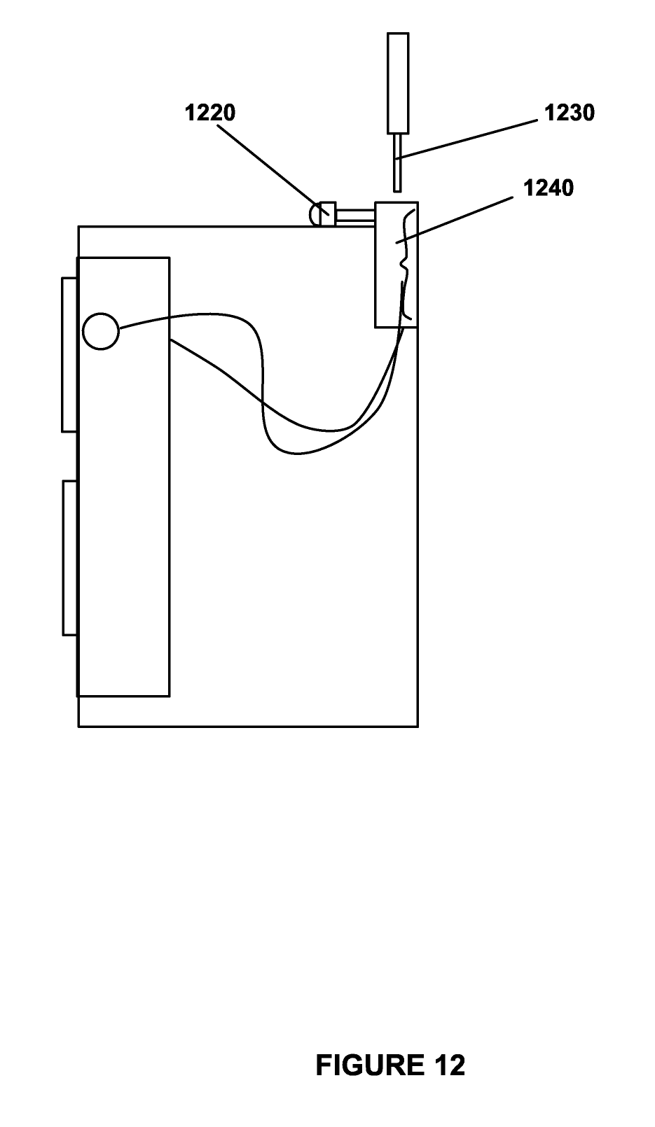

FIG. 12 shows an embodiment of a pre-wired electrical device. The device is shown with transmission wires 1230 being connected via a connection port 1240 on a top sidewall of the housing. The connection port includes a wire cap 1220, here shown as a compression plate to retain the transmission wire at the connection port. In this embodiment, a user inserts either an input electrical wire or both an input and an output wire, into the connection port at the top of the housing, the wires are engaged with blades in the port and in electrical communication with the prewired elements inside the housing. The user then tightens down the wire cap reversibly securing the wires, completing that portion of the installation. In this embodiment, the relay wire is in electrical communication with the blade, and the transmission wire will be secured upon insertion into the connection port.

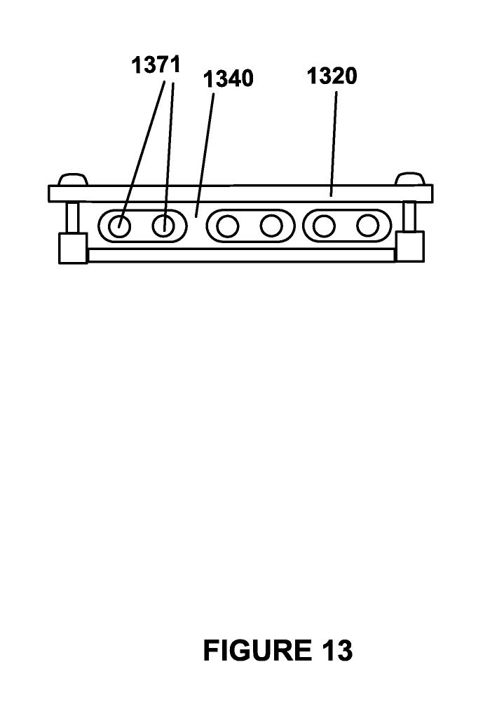

FIG. 13 shows a top view of a connection housing 1350 with multiple connection ports. In this embodiment, the wire cap consists of a horizontal plate and two screws for tightening the transmission wire in place to secure it. FIG. 13b shows a top view of an embodiment of a connection port with individual wire insertion slots and the horizontal plate securing arrangement.

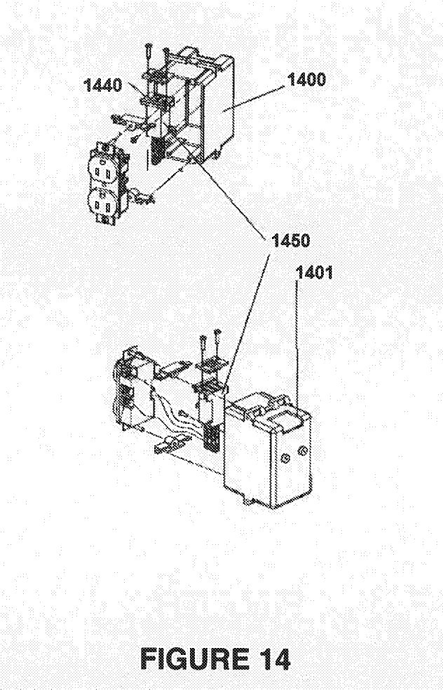

FIG. 14 shows two views of an embodiment of a prewired electrical box. In this embodiment, the housing 1400 includes a connector housing aperture 1401, formed in a top wall of the housing. The aperture allows access to the connector housing 1450. The drawing shows an exploded view of the embodiments with an outlet positioned for installation with optional positioners. In this embodiment, the connector housing is installed in the rear of the housing and may be secured with screws to the rear of the housing. The connector ports 1440 on the top of the connector housing will then be accessible for transmission wire installation once the connector housing is attached in the aperture. Extending from the bottom of the connector housing is a set of connector contacts for connection to the outlet (as shown in FIG. 14b).

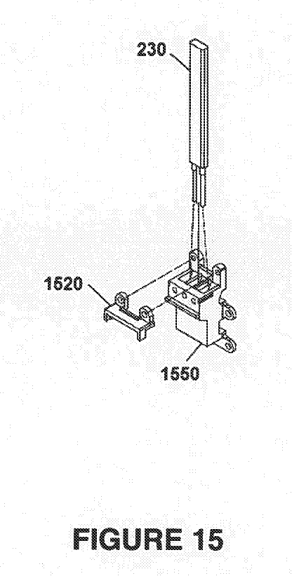

FIG. 15 shows an embodiment of a connector housing 1550 with a transmission wire ready for installation. The connector housing includes connector ports, attachment flanges with apertures for securing the connector housing to a housing, an internally includes the requisite electrical communication blades (not shown) for transmitting current from the transmission wires to the outlet. Here, the connector housing further includes a wire cap 1520. After installation of the required transmission wire(s) the wire cap is secured horizontally using the optional slides along the lower flanges, in conjunction with fasteners, reversibly securing the wire cap to the connector housing.

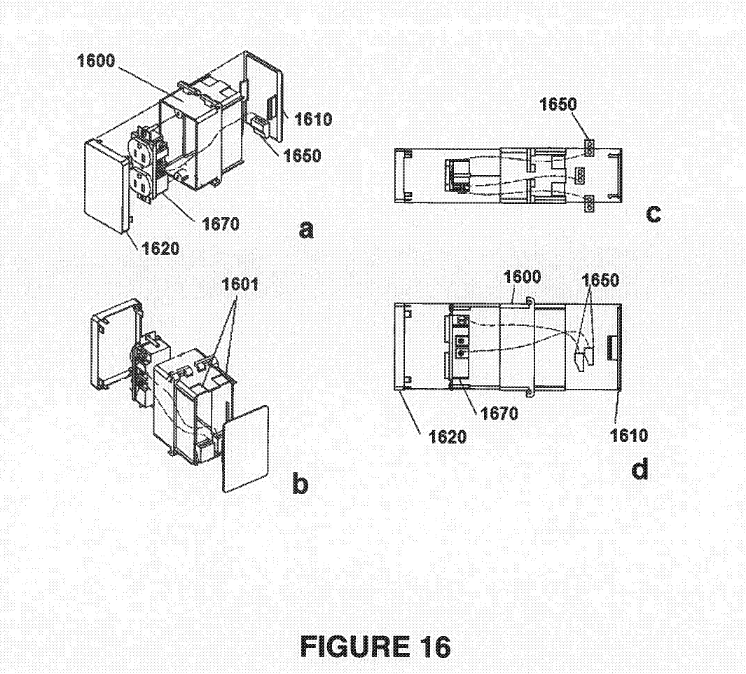

FIG. 16 shows several views of an embodiment of a prewired electrical box. Here, the box includes a housing 1600 comprising four side walls, a back plate 1610 and a front plate 1620. Optionally, both the front and back plates may be reversibly attached to the respective open sides of the housing. The device further includes an outlet, 1670, secured in the housing and connected to connector housing(s) 1650. Here, the connector housings are associated with the rear plate of the box. FIG. 16b shows, optionally, the housing may have at least one connector housing 1601 aperture formed in a side of the housing. FIG. 16c shows a top view with multiple connector housings, each with three ports for accepting a transmission wire, and prewired to communicate electricity with the outlet. Optionally, the connector housings are prewired to the outlet, but are otherwise free-floating—not secured to any surface of the housing. FIG. 16d is a side view of the previous embodiments.

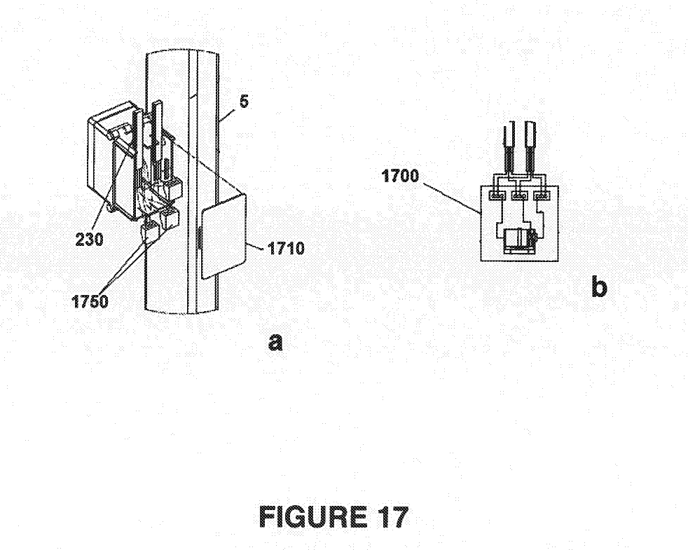

FIG. 17 shows an embodiment of a prewired electrical box in use associated with a structural element 5. Here, the back plate 1710 has been removed to show transmission wires being inserted into push-in type connectors in the connector housing(s) 1750. 17b shows an embodiment of a wiring diagram for a pre-wired electrical box 1700 from a top view.

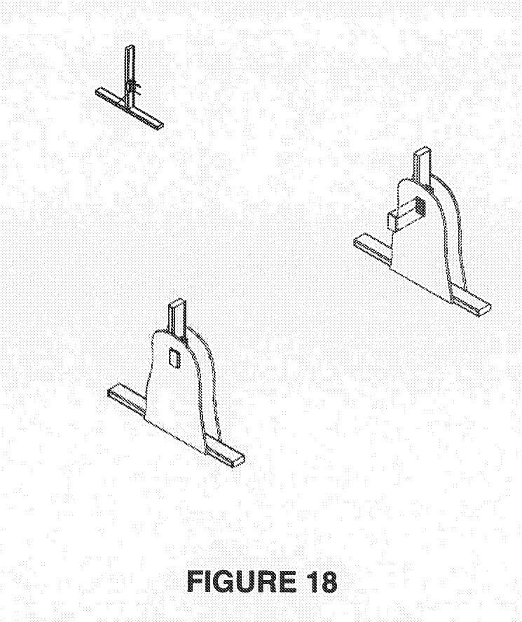

FIG. 18 shows several views of embodiments of prewired electrical boxes in use, associated with portions of a structural wall.

In an example embodiment, multiple devices can be wired in series. In such an example, a transmission wire would connect to a device to supply the outlet with electrical current, and a secondary transmission wire would leave the housing and connect to connection port of a second device. Another transmission wire would leave the second device and connect to a connection port of another device. The number of devices which can be connected in series is determined by sound wiring practices.

In an example embodiment, multiple devices can be wired in parallel. In such an example, a transmission wire would connect to a junction box, as disclosed below, and N transmission wires would leave the junction box to connect to the respective connection port of N housings, where N is an integer greater than or equal to one. The number of devices which can be connected in parallel is determined by sound wiring practices.

During use, the skilled craftsman secures a junction box to a collar tie in an attic of the residential building, and the skilled craftsmen runs an electrical transmission line from a voltage source to the junction box. The electrical transmission line is stripped of insulation and it slides into a connection port on the junction box housing. Two tabs are displaced which exerts compressive forces on the electrical transmission wire which secures it to the junction box. The skilled craftsmen then runs the electrical transmission line from an outlet port on the junction box to a connection port on the light switch housing, which is installed like on the electrical outlet housing above. A secondary electrical transmission line leaves the light switch housing through an outlet port, and the secondary electrical transmission line is installed on the light bulb housing like the electrical outlet housing above. The light switch and light bulb are now in series. Finally, the skilled craftsman connects an electrical transmission line from an outlet port on the junction box to the connection port of the second electrical outlet. The light switch and light bulb combination are in parallel with the second electrical outlet. The skilled craftsman job is complete.

Sheet rock and wood paneling is installed in the rooms where the skilled craftsman worked, and any person can finalize the skilled craftsman's job by moving the outlet means from a first to second position by using the positioner. Once the outlet means are secured in place, the same person who finalized the craftsman's installation or a different person can install decorative face plates on the electrical device housing.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. An apparatus for simplifying the wiring of a structure, comprising:
a housing comprising a back wall and side walls perpendicular to the back wall defining a space for an outlet, a connector housing arranged to transmit electricity from a transmission wire to an outlet, and relay wires connecting the connector housing to the outlet.

2. The apparatus of claim 1 further comprising a connector housing aperture formed through a wall of the housing.

3. The apparatus of claim 1 further comprising a connection port accessible through the connector port aperture, the connection port sized and shaped to accept a transmission wire.

4. The apparatus of claim 3 further comprising a relay plug for inserting a transmission wire, the relay plug positioned to accept the transmission wire via the connection port.

5. The apparatus of claim 2 further comprising a means for retaining the transmission wire positioned in the connection port.

6. The apparatus of claim 2 further comprising contacts for transmitting electrical current from the transmission wire.

7. The apparatus of claim 6 wherein the contacts are positioned in the connector housing and are adapted for electrical communication between a transmission wire and a relay wire.

8. The apparatus of claim 7 further comprising a removable front cover.

9. The apparatus of claim 8 wherein the back wall is reversibly detachable for access to the interior of the housing.

10. The apparatus of claim 7 wherein the back wall is reversibly detachable for access to the interior of the housing.

11. The apparatus of claim 1 further comprising a removable front cover.

12. The apparatus of claim 1 wherein the back wall is reversibly detachable for access to the interior of the housing.

13. A device for transmitting electricity comprising:
a housing including four side walls, and at least one aperture formed through one side wall for insertion of a transmission wire;
an outlet, prewired in the housing and adapted to accept electricity from a connector;
a removable front plate;
a removable back plate; and
a connector adapted to receive transmission wire housed in a connector housing, the connector wired to transmit electricity to the outlet through relay wires, the connector comprising a relay plug and a connection port, the connection port including electrical communication blades for connecting the transmission wires to the relay wires.

14. A kit for use in wiring an existing structure comprising, at least one of the device of claim 13 and a plurality of wires of preselected lengths and instructions for installing the device and wires in the structure.
